(19) United States
(12) Patent Application Publication
(10) Pub. No.: US 2014/0053781 A1
(43) Pub. Date: Feb. 27, 2014

(54) PET WATER FOUNTAIN

(71) Applicant: Cynthia Lewis, Panama City, FL (US)

(72) Inventor: Cynthia Lewis, Panama City, FL (US)

(21) Appl. No.: 13/595,965

(22) Filed: Aug. 27, 2012

(51) Int. Cl. A01K 7/00

(52) U.S. Cl. 119/73

(57) ABSTRACT

The present invention is a pet water fountain that includes a solar panel with a rechargeable battery, a quantity of water consumed by a pet that is heated by the solar panel to prevent bacteria and algae growth, a plurality of water spouts and valves that disperse the water heated, a filter and pump that includes a central filter and a water pump system and a reservoir area that includes a warming element. The pet water fountain also includes a water bottle that contains water that is treated by the filter and pump, a stainless steel bowl that contains the dispersed water, a plurality of rubber feet that are evenly positioned underneath the stainless steel bowl and a j-shaped cleaning tool utilized to clean the pet water fountain.

### TECHNICAL FIELD & BACKGROUND

Currently there lacks an option for a recycling water fountain that does not require electricity as a power source. Pet owners, who utilize current purification systems, still have to consistently change a unit's water supply in an effort to ensure a bacteria-free drink is available for their pet.

The present invention generally relates to a water fountain. More specifically, the invention is a pet water fountain.

It is an object of the invention to provide a pet water fountain that is solar powered and can be utilized without an electrical outlet.

It is an object of the invention to provide a pet water fountain that keeps a pet's drinking water sanitary for a relatively greater period of time by utilizing solar power to filter the drinking water.

It is an object of the invention to provide a pet water fountain that allows a pet water bowl to remain cleaner for a relatively longer period of time without algae growth.

What is really needed is a pet water fountain that is solar powered and can be utilized without an electrical outlet that keeps a pet's drinking water sanitary for a relatively greater period of time by utilizing solar power to filter the drinking water that allows a pet water bowl to remain cleaner for a relatively longer period of time without algae growth.

### BRIEF DESCRIPTION OF THE DRAWINGS

The present invention will be described by way of exemplary embodiments, but not limitations, illustrated in the accompanying drawings in which like references denote similar elements, and in which:

FIG. 1A illustrates a top view of a pet water fountain, according to an embodiment of the present invention.

FIG. 1B illustrates a side view of a pet water fountain, according to an embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention. However, the order of description should not be construed as to imply that these operations are necessarily order dependent. In particular, these operations need not be performed in the order of presentation.

The phrase “in one embodiment” is utilized repeatedly. The phrase generally does not refer to the same embodiment, however, it may. The terms “comprising”, “having” and “including” are synonymous, unless the context dictates otherwise.

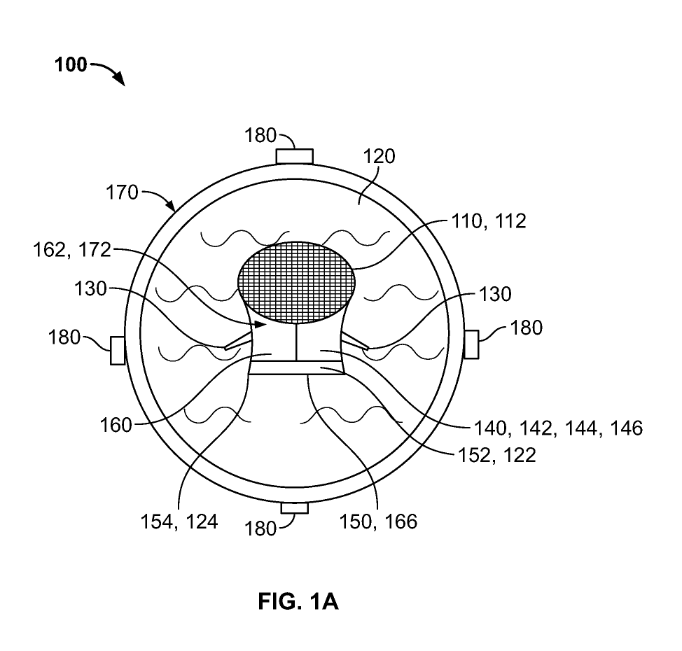

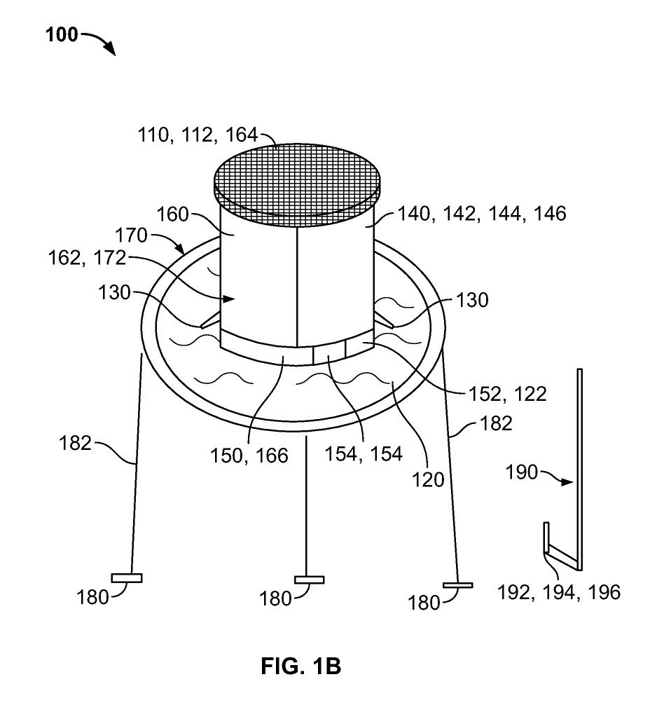

FIG. 1A illustrates a top view of a pet water fountain 100, according to an embodiment of the present invention.

The pet water fountain 100 includes a solar panel 110, a quantity of water 120, a plurality of water spouts and valves 130, a filter and pump 140, a reservoir area 150, a water bottle 160, a stainless steel bowl 170 and a plurality of rubber feet 180. The solar panel 110 includes a rechargeable battery 112. The solar panel 110 receives exterior light such as sunlight or any other suitable light and converts light energy from the sunlight into electrical energy. The rechargeable battery 112 provides stored electrical energy when the solar panel 110 is inoperable which is typically in a dark environment or evening hours. The water 120 is consumed by a pet that is heated by the solar panel 110 to impede or prevent bacteria and algae growth. The water spouts and valves 130 include 4 water spouts and valves that disperse water 120 heated from the solar panel 120, but can be any suitable number of water spouts such as 2, 3, 5, 6 or more water spouts. The water spouts and valves 130 are evenly spaced to provide relatively even dispersion of water.

The filter and pump 140 includes a central filter 142 and a water pump system 144 that employs three layers of charcoal 146 and a sponge 148 to prevent algae and contaminations from relatively rapidly growing within the filter and pump 140 and water 120. The water pump system 144 pumps the water 120 heated by the solar panel 110 and the central filter 142 and the three layers of charcoal 146 filter the water 120 as well. The three layers of charcoal 146 are a well suited quantity of charcoal filter layers that provide a well suited quality of filtered water 120. The reservoir area 150 contains relatively warm water 122 or relatively cold water 124 to adjust the temperature of the water 120 dispersed by the water spouts and valves 130. The reservoir area 150 includes a warming element 152 and a chilling element 154 that is powered by the solar panel 110 and can contain approximately 1 gallon of water but can contain any other suitable quantity of water. The water bottle 160 contains water 120 that is to be treated by the adjacent filter and pump 140. Together, the water bottle 160 and the adjacent filter pump 140 forms a receptacle 162 that has a top 164 and a bottom 166. The solar panel 110 is disposed on top 164 of the receptacle 162 and the reservoir area 150 is on the bottom 166 of the receptacle 162. The stainless steel bowl 170 has a middle portion 172 that contains water 120 that is dispersed by the water spouts and valves 130 and the filter and pump 140 that is directly consumed by the pet. The pet is typically a cat, a dog, a cow, a horse or other suitable pet. The receptacle 162 is positioned in the middle portion 172 of the stainless steel bowl 170 to generate water 120 that is dispersed by the water spouts and valves 130 and the filter and pump 140 that is directly consumed by the pet. The rubber feet 180 are evenly positioned underneath the stainless steel bowl 170 to prevent the stainless steel bowl 170 from slipping.

FIG. 1B illustrates a side view of a pet water fountain 100, according to an embodiment of the present invention. The pet water fountain 100 illustrated and described in FIG. 1A is similar to the same pet water fountain 100 illustrated and described in FIG. 1B and includes a similar solar panel 110, quantity of water 120, plurality of water spouts and valves 130, filter and pump 140, reservoir area 150, water bottle 160, stainless steel bowl 170 and rubber feet 180 as illustrated and described in FIG. 1A.

The pet water fountain 100 also includes a j-shaped cleaning tool 190. The pet water fountain 100 can also be elevated by a stand 182 with a plurality of rubber feet 180 to accommodate one or more taller animals as well. The stand 182 can also provide stability to the pet water fountain 100 when in use. The j-shaped cleaning tool 190 can be utilized to clean the pet water fountain 100, especially the stainless steel bowl 170. The j-shaped cleaning tool 190 has a first end 192 that includes a cleaning sponge 194 or a cleaning pad 196 disposed on the first end 192 of the j-shaped cleaning tool 190.

The pet water fountain is a solar powered filtration system that ensures clean and desired drinking water for both indoor and outdoor pets. Made with stainless steel components, the pet water fountain includes a central filter and a water pump system that employs three layers of charcoal and a sponge to prevent algae and contaminations such as bacteria from rapidly growing. Built-in a plurality of different sizes, the pet water fountain utilizes solar energy, in addition to a back-up rechargeable battery, to power a warming or chilling unit embedded within the reservoir area, thereby giving the pet owner the ability to determine the water's temperature. The pet water fountain may be readily available at renowned pet and/or agricultural supply retailers. The pet water fountain possesses four adjustable spouts and valves to control the water flow consistency and the water height access required by animals, such as dogs, cats, cattle or other small mammals. The feature of an eco-friendly filtration system, having a submersible pump, a four-week filter life and a rubber foundation to prevent movement during use, affords animal caregivers with a well suited alternative to providing fresh water to their endeared pets.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

1. A pet water fountain, comprising:
a solar panel that includes a rechargeable battery, said solar panel receives exterior sunlight light and converts light energy from said sunlight into electrical energy, said rechargeable battery provides stored electrical energy when said solar panel is inoperable;
a quantity of water consumed by a pet, said water is heated by said solar panel to prevent bacteria and algae growth;
a plurality of water spouts and valves that disperse said water heated from said solar panel;
a filter and pump that includes a central filter and a water pump system, said central filter employs three layers of charcoal and a sponge to filter said water, said central filter to prevent said bacteria and algae growth within said filter and pump and said water;
a reservoir area that includes a warming element that is powered by said solar panel;
a water bottle that contains said water that is treated by said filter and pump, said water bottle and said filter and pump are adjacent and form a receptacle, said receptacle has a top and a bottom, said solar panel is disposed on said top of said receptacle and said reservoir area is disposed on said bottom of said receptacle;
a stainless steel bowl that has a middle portion, said stainless steel bowl contains said water that is dispersed by said water spouts and valves and said filter and pump, said water is consumed by said pet in said stainless steel bowl; and
a plurality of rubber feet that are evenly positioned underneath said stainless steel bowl, said rubber feet prevent said stainless steel bowl from slipping; and
a j-shaped cleaning tool with a first end, said j-shaped cleaning tool is utilized to clean said pet water fountain, said first end includes a selected one of a cleaning sponge and a cleaning pad disposed on said first end of said j-shaped cleaning tool.

2. The pet water fountain according to claim 1, wherein said solar panel is inoperable in a dark environment.

3. The pet water fountain according to claim 1, wherein said water spouts and valves are evenly spaced to provide even dispersion of said water.

4. The pet water fountain according to claim 1, wherein said water pump system pumps said water heated by said solar panel.

5. The pet water fountain according to claim 1, wherein said reservoir area includes a cooling element that is powered by said solar panel.

6. The pet water fountain according to claim 5, wherein said water pump system pumps said water cooled by said cooling element.

7. The pet water fountain according to claim 1, wherein said reservoir area contains warm water to adjust a temperature of said water dispersed by said water spouts and valves.

8. The pet water fountain according to claim 7, wherein said reservoir area contains cold water to adjust said temperature of said water dispersed by said water spouts and valves.

9. The pet water fountain according to claim 1, wherein said reservoir area contains approximately 1 gallon of water.

10. The pet water fountain according to claim 1, wherein said pet is a cat.

11. The pet water fountain according to claim 1, wherein said pet is a dog.

12. The pet water fountain according to claim 1, wherein said pet is a cow.

13. The pet water fountain according to claim 1, wherein said pet is a horse.

14. The pet water fountain according to claim 1, wherein said receptacle is positioned in said middle portion of said stainless steel bowl.

15. The pet water fountain according to claim 1, wherein said receptacle generates said water that is dispersed by said water spouts and valves and said filter and pump that is consumed by said pet.

16. The pet water fountain according to claim 1, wherein said pet water fountain is elevated by a stand with said plurality of rubber feet, said stand to accommodate one or more taller animals and provide stability to said pet water fountain.

17. A pet water fountain, comprising:
a solar panel that includes a rechargeable battery, said solar panel receives exterior sunlight light and converts light energy from said sunlight into electrical energy, said rechargeable battery provides stored electrical energy when said solar panel is inoperable, said solar panel is inoperable in a dark environment;
a quantity of water consumed by a pet, said water is heated by said solar panel to prevent bacteria and algae growth;
a plurality of water spouts and valves that disperse said water heated from said solar panel, said water spouts and valves are evenly spaced to provide even dispersion of said water;
a filter and pump that includes a central filter and a water pump system, said central filter employs three layers of charcoal and a sponge to filter said water, said central filter to prevent said bacteria and algae growth within said filter and pump and said water and said water pump system pumps said water heated by said solar panel;
a reservoir area that includes a warming element that is powered by said solar panel, said reservoir area includes a cooling element that is powered by said solar panel, said reservoir area contains warm water to adjust a temperature of said water dispersed by said water spouts and valves, said reservoir area contains cold water to adjust said temperature of said water dispersed by said water spouts and valves and said water pump system pumps said water cooled by said cooling element;
a water bottle that contains said water that is treated by said filter and pump, said water bottle and said filter and pump are adjacent and form a receptacle, said receptacle has a top and a bottom, said solar panel is disposed on said top of said receptacle and said reservoir area is disposed on said bottom of said receptacle;
a stainless steel bowl that has a middle portion, said stainless steel bowl contains said water that is dispersed by said water spouts and valves and said filter and pump, said water is consumed by said pet in said stainless steel bowl and said receptacle is positioned in said middle portion of said stainless steel bowl; and
a plurality of rubber feet that are evenly positioned underneath said stainless steel bowl, said rubber feet prevent said stainless steel bowl from slipping; and
a j-shaped cleaning tool with a first end, said j-shaped cleaning tool is utilized to clean said pet water fountain, said first end includes a selected one of a cleaning sponge and a cleaning pad disposed on said first end of said j-shaped cleaning tool.

18. The pet water fountain according to claim 17, wherein said reservoir area contains approximately 1 gallon of water.

19. The pet water fountain according to claim 17, wherein said pet is a selected one of a cat, a dog, a cow and a horse.

20. The pet water fountain according to claim 17, wherein said pet water fountain is elevated by a stand with said plurality of rubber feet, said stand to accommodate one or more taller animals and provide stability to said pet water fountain.
